(19) United States
(12) Patent Application Publication
(10) Pub. No.: US 2006/0238036 A1
(43) Pub. Date: Oct. 26, 2006

(54) Electronic apparatus including printed circuit board

(75) Inventors: Kazuyuki Nagata, Echizen-shi (JP); Saori Kimura, Echizen-shi (JP); Sawako Yoshida, Echizen-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/407,288

(22) Filed: Apr. 20, 2006

(30) Foreign Application Priority Data
Apr. 21, 2005 (JP) 2005-123956

(51) Int. Cl. H02G 5/06

(52) U.S. Cl. 307/147

(57) ABSTRACT

Circuit board coordinate position symbols of respective electronic components arranged on a microcomputer board based on an X-axis direction and a Y-axis direction of the microcomputer board are displayed in the vicinity of reference numbers or component symbols representing the respective electronic components and displayed on a microcomputer circuit diagram. Circuit diagram coordinate position symbols of respective reference numbers or component symbols representing the respective electronic components and displayed on the microcomputer circuit diagram are displayed in the vicinity of the reference numbers or component marks corresponding to the respective electronic components and displayed on the microcomputer board. Front or rear identification symbols identifying a front surface or a rear surface of a video and voice processing board, which is a both-sided mount board, are added to the respective circuit board coordinate position symbols on the circuit diagram of the board and displayed on the circuit diagram.

### BACKGROUND OF THE INVENTION

1. Field of the Invention

The present invention relates to an electronic apparatus that includes a printed circuit board on which electronic components are arranged. More specifically, the present invention relates to an electronic apparatus that includes a printed circuit board, wherein coordinate positions of a plurality of electronic components arranged on the printed circuit board can be easily identified by referring to a circuit diagram and coordinate positions of component symbols and the like displayed on the circuit diagram and representing the respective electronic components can be easily identified by referring to the printed circuit board.

2. Description of the Related Art

Conventionally, when a printed circuit board incorporated in an electronic apparatus is checked or repaired due to a failure of the electronic apparatus, a fault portion is checked and repaired while comparing the printed circuit board of the electronic apparatus with a circuit diagram thereof. Various measures have been conventionally taken to facilitate identifying respective electronic components arranged on the printed circuit board while referring to component symbols representing the respective electronic components and displayed on the circuit diagram, and further identifying a wiring, a signal path or the like between the electronic components arranged on the printed circuit board while referring to the component symbols thereof displayed on the circuit diagram.

Japanese Patent Application Laid-Open No. 5-37099, for example, discloses “a printed wiring board”. This document proposes a method for identifying coordinate positions of a plurality of electronic components arranged on the printed wiring board by drawing parallel lines generally in a checkered fashion at certain intervals on a surface of the printed wiring board both in an X-axis direction and a Y-axis direction, providing rough position identification symbols in the X-axis direction and the Y-axis direction so as to be able to roughly specify coordinate positions of the respective electronic components, and providing graduation position identification symbols corresponding to graduations that subdivide the intervals.

Japanese Patent Application Laid-Open No. 2004-342788 discloses “a method for identifying components on a printed circuit board”. This document proposes a method for displaying identification marks that indicate on which surface the respective electronic components are arranged, on a front surface or on a rear surface of the printed circuit board, in the vicinity of component symbols or reference numbers representing the respective electronic components and displayed on a circuit diagram that illustrates a circuit of the printed circuit board having the electronic components arranged both on the front surface and the rear surface thereof.

According to the conventional technique disclosed in Japanese Patent Application Laid-Open No. 5-37099, it is possible to easily specify the coordinate positions of the respective electronic components arranged on the printed circuit board by the coordinate lines drawn generally in the checkered fashion and the position identification symbols, both of which are displayed on the printed circuit board. However, this conventional technique has the following disadvantages. Information on the coordinate positions of the respective electronic components arranged on the printed circuit board is not illustrated on the circuit diagram. Due to this, even if this printed circuit board is compared with the circuit diagram for a coordinate position of a specific electronic component arranged on the printed circuit board, a component symbol representing the specific electronic component arranged on the printed circuit board cannot be easily identified by referring to the circuit diagram. Conversely, information on the coordinate positions of component symbols representing the respective electronic components and displayed on the circuit diagram is not shown on the printed circuit board. Due to this, an electronic component corresponding to a specific component symbol displayed on the circuit diagram cannot be easily identified by referring to the printed circuit board. In addition, a fault position on the printed circuit board cannot be easily confirmed while grasping the wiring or signal path between the component symbols representing the respective electronic components and displayed on this circuit diagram.

According to the conventional technique disclosed in Japanese Patent Application Laid-Open No. 2004-342788, the identification marks are shown in the vicinity of the component symbols or reference numbers displayed on the circuit diagram, the identification marks indicating on which surface the respective electronic components corresponding to the component symbols are arranged, on the front surface or on the rear surface of the printed circuit board. However, the coordinate positions on the printed circuit board of the electronic components arranged on the printed circuit board are not indicated on the circuit diagram. Due to this, even if the circuit diagram is compared with the printed circuit board, a specific electronic component corresponding to a specific component symbol and displayed on the circuit diagram cannot be easily identified from among the plurality of electronic components arranged on the printed circuit board, and a specific component symbol representing a specific electronic component arranged on the printed circuit board cannot be easily identified from among the plurality of component symbols displayed on the circuit diagram.

### SUMMARY OF THE INVENTION

The present invention has been achieved to solve the conventional disadvantages. It is an object of the present invention to provide an electronic apparatus that includes a printed circuit board, wherein coordinate positions on the printed circuit board of a plurality of electronic components arranged on the printed circuit board can be easily identified only by referring to a circuit diagram, coordinate positions on the circuit diagram of a plurality of component symbols and the like representing the respective electronic components and displayed on the circuit diagram can be easily identified only by referring to the printed circuit board, and on which surface the respective electronic components are arranged, on a front surface or on a rear surface of the printed circuit board, can be easily recognized only by referring to the circuit diagram.

According to a first aspect of the present invention, there is provided an electronic apparatus that includes a printed circuit board, the printed circuit board formed by a board design CAD apparatus according to a board design corresponding to a circuit diagram designed by a circuit design CAD apparatus, the printed circuit board having graduations displayed both in an X-axis direction and a Y-axis direction on an outer periphery thereof, while the X-axis direction and the Y-axis direction are specified, and the printed circuit board further having a position indication symbol displayed for indicating a position defined by the graduations, hereby enabling coordinate positions on the printed circuit board of the respective electronic components arranged on the printed circuit board to be identified by the graduations and the position indication symbol both displayed on the printed circuit board, wherein the circuit design CAD apparatus stores and holds coordinate position data on the respective electronic components arranged on the printed circuit board designed by the board design CAD apparatus, the circuit design CAD apparatus displays circuit board coordinate position symbols of the respective electronic components based on the stored and held coordinate position data in the vicinity of component display symbols representing the respective electronic components and displayed on the circuit diagram of the printed circuit board, and the coordinate positions of the respective electronic components on the printed circuit board can be identified by the circuit board coordinate position symbols displayed on the circuit diagram.

According to a second aspect of the present invention, there is provided an electronic apparatus that includes the printed circuit board, the circuit diagram of the printed circuit board having graduations displayed on an outer periphery of the circuit diagram both in the X-axis direction and the Y-axis direction, while the X-axis direction and the Y-axis direction are specified, and the circuit diagram further having a position indication symbol displayed for indicating a position defined by the graduations, hereby enabling coordinate positions on the circuit diagram of respective component display symbols displayed on the circuit diagram and corresponding to the respective electronic components arranged on the printed circuit board to be identified by the graduations and the position indication symbol both displayed on the circuit diagram, wherein the board design CAD apparatus stores and holds coordinate position data on the respective component display symbols representing the respective electronic components and displayed on the circuit diagram by the circuit design CAD apparatus, the board design CAD apparatus displays circuit diagram coordinate position symbols of the respective component display symbols based on the stored and held coordinate position data in the vicinity of component arrangement symbols displayed on the printed circuit board for specifying the positions to arrange the respective electronic components on the printed circuit board, and the coordinate positions on the circuit diagram of the respective component display symbols representing the respective electronic components can be identified by the circuit diagram coordinate position symbols displayed on the printed circuit board.

According to a third aspect of the present invention, there is provided an electronic apparatus that includes the printed circuit board according to the first or second aspect, wherein the circuit board coordinate position symbols corresponding to the respective electronic components and displayed on the circuit diagram are displayed while front or rear identification symbols that specify a front surface or a rear surface of the printed circuit board are added to the circuit board coordinate position symbols, the front or rear identification symbols making it possible to specify on which surface of the printed circuit board the respective electronic components are arranged, on the front surface or on the rear surface of the printed circuit board.

According to the first aspect of the present invention, if the respective electronic components arranged on the printed circuit board incorporated in the electronic apparatus are checked or repaired when a failure occurs to the electronic apparatus that includes the printed circuit board, specific electronic components arranged on the printed circuit board are easily located by referring to circuit board coordinate position symbols corresponding to the specific electronic components and displayed on the circuit diagram while comparing the printed circuit board of the electronic apparatus with the circuit diagram thereof. In addition, component display symbols displayed on the circuit diagram, including reference numbers or component symbols representing the respective electronic components arranged on the circuit diagram, and the wiring, the signal path or the like among the respective component symbols on the circuit diagram are easily grasped. It is thereby possible to check a fault position, check the component number and the rated value of the electronic component to which the failure occurs based on the reference number or the like, and promptly repair the fault portion.

According to the second aspect of the present invention, if the respective electronic components arranged on the printed circuit board incorporated in the electronic apparatus are checked or repaired when a failure occurs to the electronic apparatus that includes the printed circuit board, specific component display symbols displayed on the circuit diagram such as reference numbers or component symbols representing respective electronic components arranged on the printed circuit board are easily located by referring to circuit diagram coordinate position symbols corresponding to the specific electronic components and displayed on the printed circuit board while comparing the printed circuit board of the electronic apparatus with the circuit diagram thereof. In addition, the component display symbols displayed on the circuit diagram, including reference numbers or the component symbols, and the wiring, the signal path or the like among the respective component symbols on the circuit diagram are easily grasped. It is thereby possible to check a fault position, check the component number and the rated value of the electronic component to which the failure occurs based on the reference number or the like, and promptly repair the fault portion.

According to the third aspect of the present invention, even if the electronic components are arranged on the front surface and the rear surface of the printed circuit board, it is possible to easily specify on which surface of the printed circuit board the respective electronic components are arranged, on the front surface or on the rear surface of the printed circuit board, only by referring to the circuit diagram. Therefore, if the respective electronic components arranged on the printed circuit board incorporated in the electronic apparatus are checked or repaired when a failure occurs to the electronic apparatus, specific component display symbols such as reference numbers or component symbols representing the specific electronic components arranged on the front surface or the rear surface of the printed circuit can be easily located by referring to the circuit diagram while comparing the printed circuit board of the electronic apparatus with the circuit diagram thereof. In addition, the component display symbols displayed on the circuit diagram, including the reference numbers or the component symbols of the respective electronic components arranged on the circuit diagram, and the wiring, signal path or the like among the respective component symbols on the circuit diagram can be easily grasped. It is thereby possible to check a fault portion, check the component number and the rated value of the electronic component to which the failure occurs based on the reference number or the like, and promptly repair the fault portion.

### BRIEF DESCRIPTION OF THE DRAWINGS

FIG. 1 is a plan view of a microcomputer circuit diagram in a state in which circuit board coordinate position symbols of electronic components arranged on a microcomputer board are displayed on the microcomputer circuit diagram according to the present invention;

FIG. 2 is a plan view of the microcomputer board in a state in which circuit diagram coordinate position symbols of component symbols and the like displayed on the microcomputer circuit diagram and corresponding to the electronic components arranged on the microcomputer board are displayed on the microcomputer board according to the present invention;

FIG. 3 is a plan view of a video and voice processing circuit diagram in a state in which circuit board coordinate position symbols of electronic components arranged on a television video and voice processing board and front or rear identification symbols that identify a front or rear surface of the board are displayed on the video and voice processing circuit diagram according to the present invention;

FIG. 4 is a plan view of the front surface of the video and voice processing board corresponding to the video and voice processing circuit diagram according to the present invention;

FIG. 5 is a plan view of the rear surface of the video and voice processing board corresponding to the video and voice processing circuit diagram according to the present invention; and

FIG. 6 is a perspective schematic view of a television set according to the present invention.

### DESCRIPTION OF THE PREFERRED EMBODIMENTS

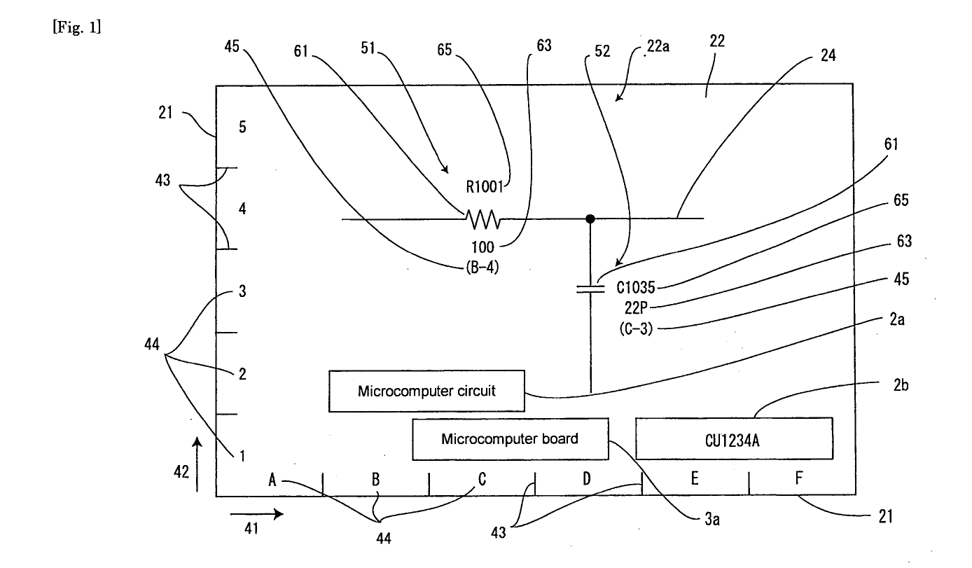

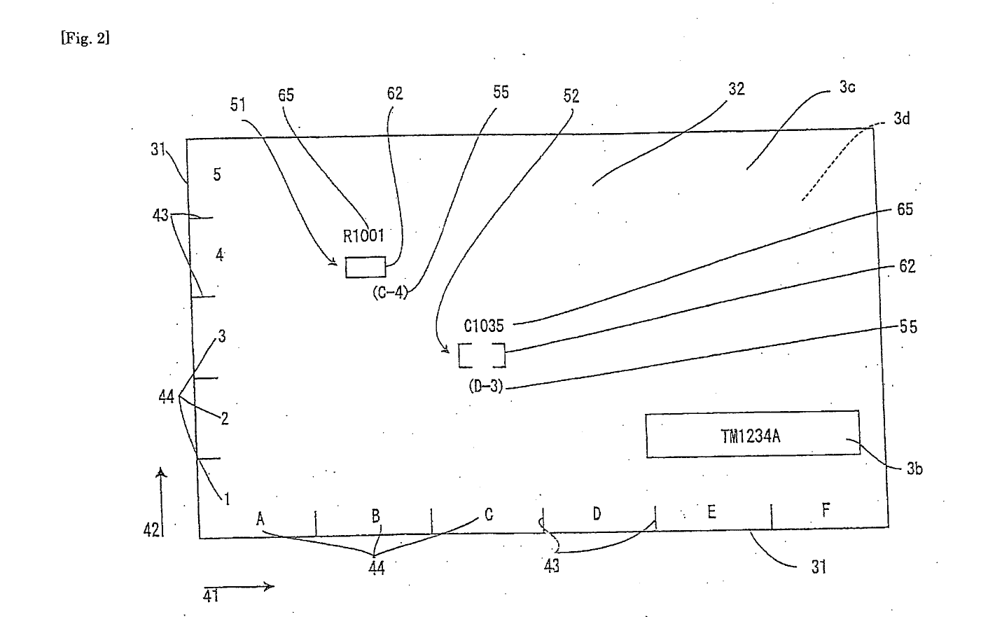

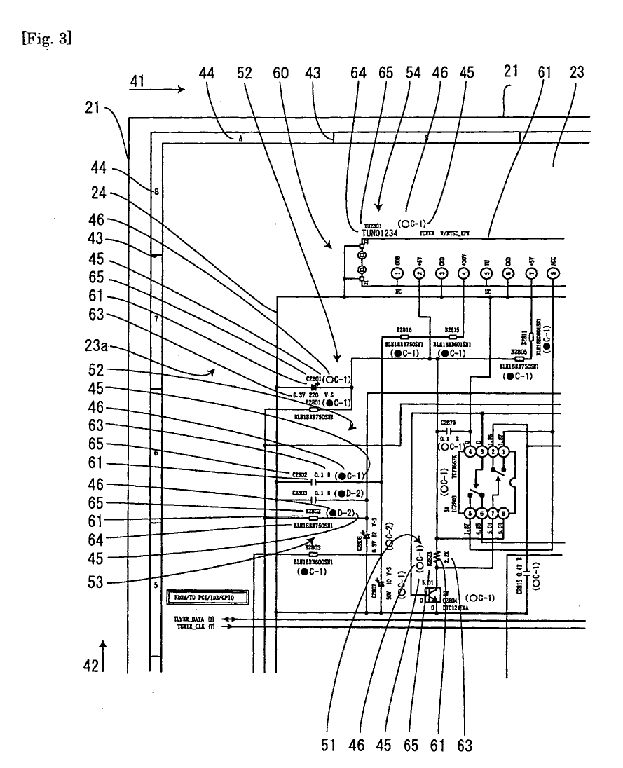

The present invention particularly relates to an electronic component coordinate position specifying method capable of easily specifying coordinate positions on a printed circuit board of a plurality of electronic components arranged on the printed circuit board by referring to a circuit diagram and coordinate positions on a circuit diagram of component display symbols including reference numbers corresponding to the respective electronic components or component symbols representing respective types thereof, both displayed on the circuit diagram, by referring to the printed circuit board. In the following description, FIG. 1 illustrates an embodiment in which coordinate positions on a printed circuit board of electronic components arranged on the printed circuit board are displayed in the vicinity of component display symbols on a circuit diagram including reference numbers and component symbols representing the respective electronic components arranged on the circuit diagram. FIG. 2 illustrates an embodiment in which coordinate positions on a circuit diagram of component display symbols displayed on a circuit diagram including reference numbers or component symbols, both representing respective electronic components, are displayed in the vicinity of component arrangement symbols on a printed circuit board including reference numbers or component marks of the respective electronic components arranged on the printed circuit board. FIGS. 3 to 5 further illustrate an embodiment in which coordinate positions on a printed circuit board of electronic components arranged on the printed circuit board are displayed in the vicinity of component display symbols including reference numbers or component symbols displayed on a circuit diagram, and in which front or rear identification symbols for specifying a front surface or a rear surface of the printed circuit board are displayed on the circuit diagram so as to be able to identify on which surface the respective electronic components are arranged, on the front surface of the printed circuit board or on the rear surface thereof. The embodiments will be described hereinafter in detail.

The most preferred embodiments of the present invention will be described hereinafter with reference to FIGS. 1 to 6. Needless to say, the present invention can be readily applied to electronic apparatuses other than those described in the embodiments within the scope of the spirit of the present invention.

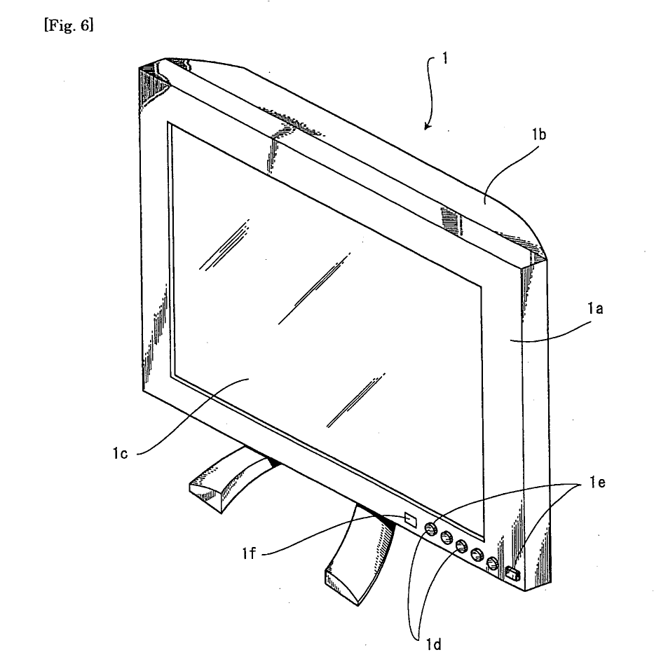

FIG. 1 is a plan view of a circuit diagram in a state in which circuit board coordinate position symbols of a plurality of electronic components arranged on a printed circuit board are displayed on the circuit diagram in the vicinity of component display symbols including reference numbers or component symbols representing the respective electronic components. FIG. 2 is a plan view of a front surface of the printed circuit board in a state in which circuit diagram coordinate position symbols of component display symbols displayed on the circuit diagram, including the reference numbers or component symbols both representing the respective electronic components, are displayed on the printed circuit board in the vicinity of component arrangement symbols including reference numbers or component marks of the respective electronic components. It is noted that FIGS. 1 and 2 are the circuit diagram and the printed circuit board that typically illustrate a microcomputer circuit diagram and a microcomputer board of a television set for explaining an example of displaying the circuit board coordinate position symbols and the circuit diagram coordinate position symbols. In addition, FIGS. 1 and 2 differ from an actual microcomputer circuit diagram and an actual microcomputer board, respectively. FIG. 6 is a perspective schematic view of a television set that includes a video and voice processing board to be described later.

Referring to FIG. 6, the television set that includes a printed circuit board according to the present invention will first be described. A television set 1 shown in FIG. 6 includes a front cabinet 1a, a rear cabinet 1b, a display unit 1c, operation buttons 1d, an operation unit 1e, and a remote controller light receiving unit 1f. The display unit 1c is arranged on the front cabinet 1a. The operation unit 1e instructs the television set 1 to operate by a user's operating the operation buttons 1d. The remote controller light receiving unit 1f receives an instruction signal from a remote controller (not shown). The operation unit 1e and the remote controller light receiving unit 1f are arranged below the display unit 1c. The rear cabinet 1b is arranged on a rear surface of the television set 1. A video and voice processing board (not shown) on which a video and voice processing circuit for processing video and voice signals, to be described later, of the television set 1 and for displaying the processed signals is arranged within the front cabinet 1a and the rear cabinet 1b.

Referring to FIGS. 1 and 2, the circuit diagram and the printed circuit board corresponding to the circuit diagram will be described. Referring to FIG. 1, the circuit diagram in a state in which circuit board coordinate position symbols of electronic components arranged on the printed circuit board shown in FIG. 2 are displayed on the circuit diagram in the vicinity of component display symbols including reference numbers or component symbols representing the respective electronic components will be described. As stated above, on a circuit diagram 22 shown in FIG. 1, a microcomputer circuit 22a of the television set 1 shown in FIG. 6 is typically formed. A “microcomputer circuit” which is a circuit name 2a of the microcomputer circuit 22a is displayed on the circuit diagram 22. A “microcomputer board” which is a board name 3a of a microcomputer board 32 indicating that the microcomputer board 32 shown in FIG. 2 is formed based on the circuit diagram 22 is displayed on the circuit diagram 22. A figure number 2b of this circuit diagram 22 is displayed as “CU1234A” on the circuit diagram 22. In this circuit diagram 22 shown in FIG. 1, a lateral direction of the circuit diagram 22 is assumed as an X-axis direction 41 and a longitudinal direction thereof is assumed as a Y-axis direction 42. Graduations 43a redisplayed at certain intervals on an outer periphery 21 of the circuit diagram 22 in the X-axis and Y-axis directions 41 and 42. Position display symbols 44 that indicate positions defined by the graduations 43 are displayed among the graduations 43 as such alphabets as A, B, C, D, E, and F in the X-axis direction 41 and as such numbers as 1, 2, 3, 4, and 5 in the Y-axis direction 42.

On this microcomputer circuit diagram 22, a component symbol 61 that indicates a resistor 51 and a component symbol 61 that indicates a capacitor 52 are displayed. A reference number 65 of the resistor 51 is displayed as “R1001” above the component symbol 61 thereof. A numeric value “100” that indicates that a rated value 63 of the resistor 51 is 100 ohms is displayed below the component symbol 61 of the resistor 51. A circuit board coordinate position symbol 45 that indicates a coordinate position of the resistor 51 on the microcomputer board 32 is displayed as (B-4) below “100” as the rated value 63. Likewise, a reference number 65 “C1035” is displayed in right of the component symbol 61 of the capacitor 52, a numeric value “22P” that indicates that a rated value 63 of the capacitor 52 is 22 picofarads is displayed below the reference number 65 of the capacitor 52. A circuit board coordinate position symbol 45 that indicates a coordinate position of the capacitor 52 on the microcomputer board 32 is displayed as (C-3) below “22P” as the rated value 63. The resistor 51 and the capacitor 52 are connected to each other by a connection line 24.

A single-sided mount board having electronic components such as the resistor 51 arranged only on a front surface 3c of the board is employed as the microcomputer board 32 shown in FIG. 2. The microcomputer board 32 is formed based on the microcomputer circuit diagram 22 shown in FIG. 1. It is thereby possible to dispense with specifying electronic components on a rear surface 3d of the microcomputer board 32. Therefore, although front or rear identification symbols 46 should be added to the circuit board coordinate position symbols displayed on the microcomputer circuit diagram 22 in the vicinity of the reference numbers 65 and the component symbols 61 of the resistor 51 and the capacitor 52, respectively, the front or rear identification symbols 46 are not displayed on the microcomputer circuit diagram 22. Only the component symbols 61 that indicate types of the respective electronic components 51 and 52, the reference numbers 65 that specify the respective electronic components 51 and 52, the rated values 63, the circuit board coordinate position symbols 45, and the like of the respective electronic components 51 and 52 are displayed.

The circuit board coordinate position symbol 45 displayed on the microcomputer circuit diagram 22 will be described, taking the resistor 51 as an example. The resistor 51 having “R1001” as the reference number 65 is arranged on the microcomputer board 32 to correspond to the microcomputer circuit diagram 22. The circuit board coordinate position symbol 45 of the resistor 51 is displayed as (B-4) on the microcomputer circuit diagram 22 in the vicinity of the reference number 65 and the component symbol 61 of the resistor 51, which indicates that position display symbols 44 of a coordinate position of the resistor 51 on the microcomputer board 32 are “B” in the X-axis direction 41 and “4” in the Y-axis direction 42, respectively.

FIG. 2 shows the microcomputer board 32 formed according to the microcomputer circuit diagram 22. The component display symbols including reference numbers 65, component symbols 61 and the like representing the respective electronic components 51 and 52 are displayed on the microcomputer circuit diagram 22 as illustrated in FIG. 1. Referring to FIG. 2, the microcomputer board 32 in a state in which circuit diagram coordinate position symbols 55 of the component display symbols including reference numbers 65, component symbols 61 and the like are displayed on the microcomputer board 32 in the vicinity of component arrangement symbols such as reference numbers 65 and component marks 62 of the respective electronic components 51 and 52 arranged on the microcomputer board 32 will be described. The microcomputer board 32 shown in FIG. 2 is formed based on the microcomputer circuit diagram 22 shown in FIG. 1. A product number 3b of this board 32 is displayed as “TM1234A”. In this circuit board 32, a lateral direction of the circuit board 32 is assumed as the X-axis direction 41 and a longitudinal direction thereof is assumed as the Y-axis direction 42 in FIG. 2. Graduations 43 are displayed at certain intervals on an outer periphery 31 of the microcomputer board 32 in the X-axis and Y-axis directions 41 and 42. Position display symbols 44 that indicate positions defined by the graduations 43 are displayed among the graduations 43 as such alphabets as A, B, C, D, E, and F in the X-axis direction 41 and as such numbers as 1, 2, 3, 4, and 5 in the Y-axis direction 42.

On this board 32, the generally rectangular component marks 62 that indicate types, arrangement directions, and rough sizes of the resistor 51 and the capacitor 52 are displayed at positions at which the resistor 51 and the capacitor 52 are arranged, respectively. The reference number 65 of the resistor 51 is displayed above the component mark 62 as “R1001”, and the circuit diagram coordinate position symbol 55 that indicates the coordinate position of the resistor 51 on the circuit diagram 22 is displayed below the component mark 62 as (C-4). Likewise, the reference number 65 of the capacitor 52 is displayed above the component mark 62 as “C1035”, and the circuit diagram coordinate position symbol 55 that indicates the coordinate position of the capacitor 52 on the circuit diagram 22 is displayed below the component mark 62 as (D-3).

The circuit diagram coordinate position symbol 55 displayed on the microcomputer board 32 will be described, taking the resistor 51 as an example. The component symbol 61 representing the resistor 51 having “R1001” as the reference number 65 is displayed on the microcomputer circuit diagram 22 to correspond to the microcomputer board 32. The circuit diagram coordinate position symbol 55 of the component symbol 61 representing the resistor 51 is displayed as (C-4) on the microcomputer board 32 in the vicinity of the reference number 65 and the component mark 62 of the resistor 51, which indicates that position display symbols 44 of a coordinate position of the component symbol 61 representing the resistor 51 on the microcomputer circuit diagram 22 are “C” in the X-axis direction 41 and “4” in the Y-axis direction 42, respectively.

The microcomputer circuit diagram 22 shown in FIG. 1 is compared with the microcomputer board 32 shown in FIG. 2 to check at which positions on the microcomputer board 32 shown in FIG. 2 corresponding to the circuit diagram 22, the resistor 51 and the capacitor 52 represented by the relevant component symbols 61 displayed on the circuit diagram 22 of the microcomputer circuit 22a shown in FIG. 1 are arranged, respectively. The circuit board coordinate position symbol 45 of the resistor 51 having “R1001” as the reference number 65 and displayed in the vicinity of the component symbol 61 thereof on the microcomputer circuit diagram 22 is (B-4). Likewise, the circuit board coordinate position symbol 45 of the capacitor 52 having “C1035” as the reference number 65 and displayed in the vicinity of the component symbol 61 thereof on the microcomputer circuit diagram 22 is (C-3). Therefore, the circuit board coordinate position symbols 45 displayed respectively in the vicinity of the component symbols 61 representing the resistor 51 and the capacitor 52 both displayed on the circuit diagram 22 shown in FIG. 1 can be easily located on the board 32 as follows. A region in which the position display symbol 44 in the X-axis direction 41 on the board 32 is B and in which the position display symbol 44 in the Y-axis direction 42 thereof is 4 is searched for the resistor 51. Likewise, a region in which the position display symbol 44 in the X-axis direction 41 is C and in which the position display symbol 44 in the Y-axis direction 42 is 3 is searched for the capacitor 52.

Further, the microcomputer board 32 shown in FIG. 2 is compared with the microcomputer circuit diagram 22 shown in FIG. 1 to check at which positions of the microcomputer circuit diagram 22 shown in FIG. 1 corresponding to the microcomputer board 32 shown in FIG. 2, the component symbols 61 representing the resistor 51 and the capacitor 52 arranged on the microcomputer board 32 are displayed, respectively. The circuit diagram coordinate position symbol 55 of the resistor 51 having “R1001” as the reference number 65 and displayed in the vicinity of the relevant component mark on the microcomputer board 32 is (C-4) Likewise, the circuit diagram coordinate position symbol 55 of the capacitor 52 having “C1035” as the reference number 65 and displayed in the vicinity of the relevant component mark on the microcomputer board 32 is (D-3). Therefore, the circuit diagram coordinate position symbols 55 of the resistor 51 and the capacitor 52 arranged on the microcomputer board 32 shown in FIG. 2 can be easily located on the microcomputer circuit diagram 22 as follows. A region in which the position display symbol 44 in the X-axis direction 41 on the circuit diagram 22 is C and in which the position display symbol 44 in the Y-axis direction 42 thereof is 4 is searched for the resistor 51. Likewise, a region in which the position display symbol 44 in the X-axis direction 41 is D and in which the position display symbol 44 in the Y-axis direction 42 is 3 is searched for the capacitor 52.

Schematic procedures for designing the microcomputer circuit diagram 22 and the microcomputer board 32 using a circuit design CAD apparatus and a board design CAD apparatus (not shown), respectively, and for displaying the circuit board coordinate position symbols 45, circuit diagram coordinate position symbols 55 and the front or rear identification symbols 46 of the respective electronic components 51 and 52 on the microcomputer circuit diagram 22 and the microcomputer board 32 will next be described.

Schematic procedures for designing the microcomputer circuit diagram 22 using the circuit design CAD apparatus will first be described. Initially, the microcomputer circuit diagram 22 is surrounded by a frame line to define the outer periphery 21 of the circuit diagram 22. The graduations 43 and the position display symbols 44 are displayed in the X-axis direction 41 and the Y-axis direction 42 of the outer periphery 21 of the circuit diagram 22. Next, the component symbols 61 of the respective electronic components such as the resistor 51 and the capacitor 52 that constitute the microcomputer circuit 22a are displayed on this circuit diagram 22, and connected to each other by the connection line 24. The reference numbers 65, the rated values 63 and the like of the respective electronic components 51 and 52 are displayed in the vicinity of the respective component symbols 61 thereof. Further, the circuit name 2a, the board name 3a, the figure number 2b of the circuit diagram 22, and the like are displayed on the microcomputer circuit diagram 22.

Schematic procedures for designing the microcomputer board 32 based on the microcomputer circuit diagram 22 using the board design CAD apparatus will next be described. Initially, the outer periphery 31 of the microcomputer board 32 is displayed in designated dimensions, and the graduations 43 and the position display symbols 44 are displayed in the X-axis direction 41 and the Y-axis direction 42 of the outer periphery 31 of the microcomputer board 32. Next, electronic components such as a switch and a connector (not shown) arrangement positions of which are designated in advance depending on a structure of the electronic apparatus such as the television set 1 are arranged at the designated positions on this board 32. The other electronic components such as the resistor 51 and the capacitor 52 arrangement positions of which are not designated in advance are arranged on the board 32. The electronic components 51 and 52 are connected to each other similarly to the connection between the component symbols 61 on the microcomputer circuit diagram 22 shown in FIG. 1. Alternatively, data on the microcomputer circuit diagram 22 obtained by the circuit design CAD apparatus may be captured into the board design CAD apparatus. In addition, the other electronic components 51 and 52 the arrangement positions of which are not designated may be arranged and connected to each other. Next, the product number 3b of this microcomputer board 32, the component marks 62 and the reference numbers 65 of the respective electronic components 51 and 52, and the like are displayed on the microcomputer board 32.

Thereafter, from among data on the microcomputer board 32, coordinate position data on the microcomputer board 32 and front or rear identification data for specifying on which surface of the microcomputer board 32 the respective electronic components 51 and 52 are arranged, on the front surface 3c or on the rear surface 3d, are output from the board design CAD apparatus, while making these pieces of data correspond to the reference numbers 65 of the respective electronic components 51 and 52. Coordinate position data and front or rear identification data on the microcomputer board 32 corresponding to the reference numbers 65 of the respective electronic components 51 and 52 arranged on the microcomputer board 32 and output from the board design CAD apparatus are captured into the circuit design CAD apparatus. The circuit design CAD apparatus stores and holds the reference numbers 65, the coordinate position data on the microcomputer board 32, and the front or rear identification data on the respective electronic components 51 and 52 captured from the board design CAD apparatus. The coordinate position data and front or rear identification data on the microcomputer board 32 stored and held in the circuit design CAD apparatus and corresponding to the reference numbers 65 of the respective electronic components 51 and 52 on the board 32 are output from the circuit design CAD apparatus to correspond to the reference numbers 65 representing the respective electronic components 51 and 52 and displayed on the microcomputer circuit diagram 22. The circuit board coordinate position symbols 45 and the front or rear identification symbols 46 can thereby be displayed in the vicinity of the component symbols 61 and the reference numbers 65 representing the respective electronic components 51 and 52 and displayed on the microcomputer circuit diagram 22.

From among data on the microcomputer circuit diagram 22, coordinate position data on the circuit diagram 22 is output from the circuit design CAD apparatus, while making these pieces of data correspond to the reference numbers 65 of the respective electronic components 51 and 52. The coordinate position data on the circuit diagram 22 corresponding to the reference numbers 65 of the respective electronic components 51 and 52 and output from the circuit design CAD apparatus are captured into the board design CAD apparatus. The board design CAD apparatus stores and holds the reference numbers 65 and the coordinate position data on the circuit diagram 22 of the respective electronic components 51 and 52 captured from the circuit design CAD apparatus. The coordinate position data on the circuit diagram 22 thus stored and held in the board design CAD apparatus and corresponding to the reference numbers 65 of the respective electronic components 51 and 52 on the circuit diagram 22 are output from the board design CAD apparatus to correspond to the reference numbers 65 corresponding to the electronic components 51 and 52 and displayed on the microcomputer board 32. The circuit diagram coordinate position symbols 55 can be thereby displayed in the vicinity of the component arrangement symbols such as the component marks 62 and the reference numbers 65 corresponding to the respective electronic components 51 and 52 and displayed on the microcomputer board 32.

If this microcomputer board 32 is formed from a plurality of microcomputer circuit diagrams 22, the circuit diagrams 22 can be specified and displayed as follows similarly to a method for displaying the front or rear identification symbols of the respective electronic components 51 and 52 arranged on the front surface 3c and the rear surface 3d of the microcomputer board 32. From among data on the plural microcomputer circuit diagrams 22, the coordinate position data on the circuit diagram 22 and circuit diagram specifying data for specifying the plural microcomputer circuit diagrams 22 are output from the circuit design CAD apparatus while making the pieces of data correspond to the reference numbers 65 of the respective electronic components 51 and 52. Coordinate position data on the circuit diagram 22 and circuit diagram specifying data, corresponding to the reference numbers 65 representing the respective electronic components 51 and 52 and displayed on the plural microcomputer circuit diagrams 22, and output from the circuit design CAD apparatus, are captured into the board design CAD apparatus. The board design CAD apparatus stores and holds the reference numbers 65, the coordinate position data on the circuit diagram 22 on the circuit diagram 22, and circuit diagram specifying data on the respective electronic components 51 and 52 captured from the circuit design CAD apparatus. The coordinate position data on the circuit diagram 22 and circuit diagram specifying data stored and held in the board design CAD apparatus and corresponding to the reference numbers 65 of the respective electronic components 51 and 52 on the plural circuit diagrams 22 are output from the board design CAD apparatus to correspond to the reference numbers 65 representing the respective electronic components 51 and 52 and displayed on the microcomputer board 32. The circuit diagram coordinate position symbols 55 and circuit diagram specifying symbols (not shown) can thereby be displayed in the vicinity of the component arrangement symbols such as the component marks 62 and the reference numbers 65 corresponding to the respective electronic components 51 and 52 and displayed on the microcomputer board 32.

As can be seen, if the respective electronic components 51 and 52 arranged oh the printed circuit board such as the microcomputer board 32 incorporated in the electronic apparatus such as the television set 1 are checked or repaired when a failure occurs to the electronic apparatus, the component symbols 61 representing the specific electronic components 51 and 52 corresponding to the reference numbers 65 or component marks 62 of the respective electronic components 51 and 52 arranged on the microcomputer board 32 are easily located on the microcomputer board 22 while comparing the microcomputer board 32 of the television set 1 with the circuit diagram 22 thereof. In addition, the reference numbers 65 or the component symbols 61 representing the respective electronic components 51 and 52 and displayed on this circuit diagram 22, and the wiring, signal path or the like between the component symbols 61 on the microcomputer circuit diagram 22 are easily grasped. It is thereby possible to easily check a fault portion, check the component number 64 and the rated value 63 of the fault electronic component 51 or 52 based on the reference number 65 or the like, and promptly repair the fault portion. In addition, using the coordinate position data on the microcomputer board 32 and the front or rear identification data stored and held in the circuit design CAD apparatus or the coordinate position data on the circuit diagram 22 stored and held in the board design CAD apparatus, a list that represents the circuit board coordinate position symbols 45 and the front or rear identification symbol 46 displayed on the circuit diagram 22 and the circuit diagram coordinate position symbols 55 displayed on the microcomputer board 32 in order of the reference numbers 65 of the respective electronic components 51 and 52c an be created. This list enables the coordinate positions on the microcomputer board 32 of the electronic components 51 and 52 corresponding to the specific component symbols 61 displayed on the circuit diagram 22, the coordinate positions on the circuit diagram 22 of the component symbols 61 representing the electronic components 51 and 52 arranged on the microcomputer board 32 and the front surface 3c or rear surface 3d of the microcomputer board 32 to be easily located.

As can be seen, according to this embodiment, it is possible to solve the following conventional disadvantages. According to the conventional techniques, even if the printed circuit board 32 is compared with the circuit diagram 22 to check the coordinate positions of the specific electronic components 51 and 52 arranged on the printed circuit board 32, the coordinate position information such as the circuit board coordinate position symbols 45 of the respective electronic components 51 and 52 arranged on the printed circuit board 32 are not illustrated on this circuit diagram 22. Due to this, the specific electronic components 51 and 52 arranged on the printed circuit board 32 cannot be easily located on the circuit diagram 22. Conversely, the coordinate position information such as the circuit diagram coordinate position symbols 55 of the component symbols 61 representing the respective electronic components 51 and 52 and displayed on the circuit diagram 22 are not illustrated on the printed circuit board 32. Due to this, the specific electronic components 51 and 52 corresponding to the component symbols 61 displayed on this circuit diagram 22 cannot be easily located on the microcomputer board 32. In addition, it is impossible to easily check the fault position while grasping the wiring or signal path between the component symbols 61 representing the respective electronic components 51 and 52 and displayed on the circuit diagram 22. According to the present invention, by contrast, the fault portion can be easily located by comparing the circuit diagram 22 with the microcomputer board 32 having the circuit diagram coordinate position symbols 55 of the component symbols representing the electronic components 51 and 52 and by comparing the microcomputer board 32 with the circuit diagram 22 having the circuit board coordinate position symbols 45 of the electronic components 51 and 52. The fault position of the electronic apparatus 1 can be, therefore, promptly checked and repaired.

Display of the circuit board coordinate position symbols 45 on the video and voice processing board of the television set 1 having electronic components arranged on the front surface 3c and the rear surface 3d of the board, and the printed circuit board front or rear identification symbol 46 according to the present invention will next be described in detail. Like constituent elements as those described before are denoted by the same reference symbols, respectively, and will not be repeatedly described herein.

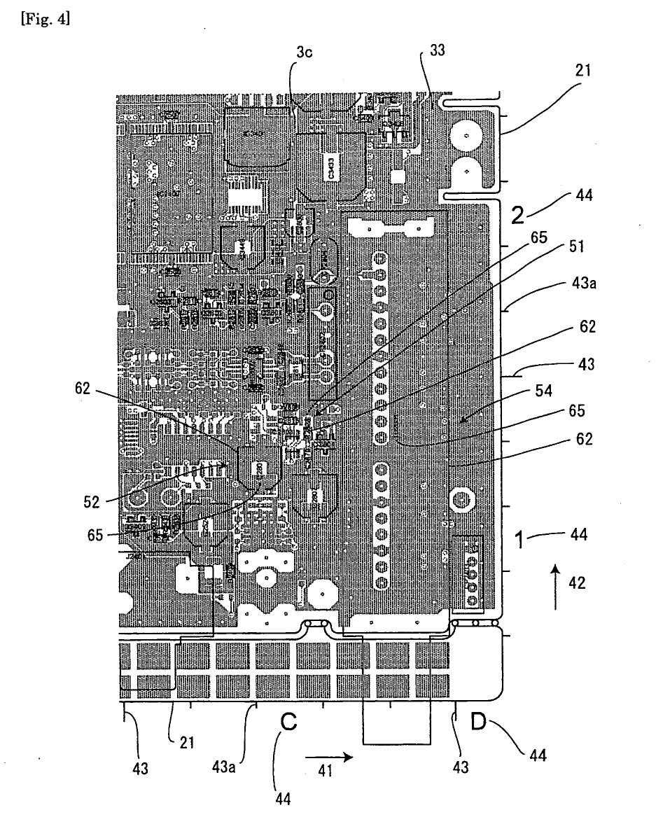

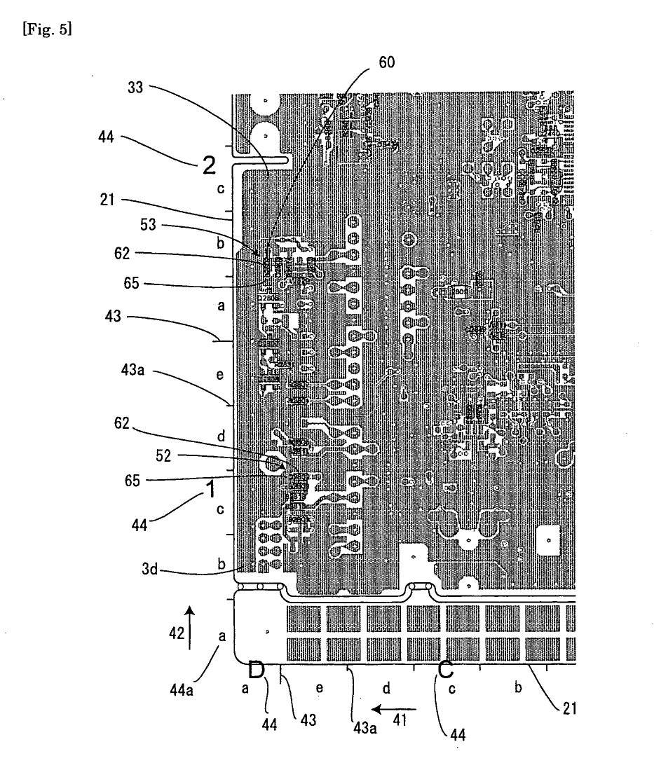

FIG. 3 is a plan view of a video and voice processing circuit diagram in a state in which circuit board coordinate position symbols 45 of electronic components arranged on the board on which a video and voice processing circuit of the television set 1 is formed and video and voice processing board front or rear identification symbols 46 that identify a front surface or a rear surface of the board are displayed in the vicinity of component display symbols such as reference numbers 65, component symbols 61 and the like representing the respective electronic components and displayed on the video and voice processing circuit diagram according to the embodiment. FIG. 4 is a plan view of the front surface 3c of the video and voice processing board corresponding to the video and voice processing circuit diagram shown in FIG. 3. FIG. 5 is a plan view of the rear surface 3d of the video and voice processing board corresponding to the video and voice processing circuit diagram shown in FIG. 3.

Referring to FIGS. 3 to 5, the video and voice processing circuit diagram on which the video and voice processing circuit or the like of the television set 1 is formed, and the video and voice processing board designed based on this video and voice processing circuit diagram will be described.

In FIG. 3, reference symbol 23 denotes the video and voice processing circuit diagram of the television set 1. On the circuit diagram 23, a video and voice processing circuit 23a of the television set 1 is formed. The circuit diagram 23 partially shows the circuit 23a. Graduations 43 are displayed at certain intervals on an upper outer periphery 21 and a left outer periphery 21 of the circuit diagram 23. Position display symbols 44 are displayed as such alphabets as A and B in the X-axis direction 41 and as such numbers as 5, 6, 7, and 8 in the Y-axis direction 42. As shown in FIGS. 4 and 5, a both-sided mount board that can arrange electronic components such as the resistor 51 and the capacitor 52 on both surfaces, i.e., the front surface 3c and the rear surface 3d of a video and voice processing board 33 is used as the video ad voice processing board 33. Because of the both-side mount board, differently from the microcomputer board 32, in the video and voice processing circuit diagram 23 as shown FIG. 3, the front or rear identification symbols 46 that indicate the front surface 3c or the rear surface 3d of the video and voice processing board 33 are added to the circuit board coordinate position symbols 45 of the respective electronic components 51 and 52. If an electronic component is arranged on the front surface 3c of the board 33, a white circle is displayed as the front or rear identification symbol 46. If an electronic component is arranged on the rear surface 3d of the board 33, a black circle is displayed as the front or rear identification symbol 46.

A component symbol 61 of a tuner 54 that selects one of broadcasting waves received by an antenna (not shown) is displayed above this video and voice processing circuit 23a in the form of an oblong rectangle. Component symbols 61 that represent a plurality of electronic components such as the resistors 51, the capacitors 52, and inductors 53 are displayed below the tuner 54, and connected to one another by a connection line 24. The reference number 65 of the tuner 54 is displayed as “TU2801”, and the component number 64 thereof is displayed as “TUN01234”. Further, the front or rear identification symbol 46 is added, as a white circle, to the circuit board coordinate position symbol 45 of the tuner 54 and displayed in right of the reference number 65 thereof. This symbol 46 indicates that the tuner 54 corresponding to the component number 64 displayed as “TUN01234” is arranged on the front surface 3c of the video and voice processing board 33 of the television set 1 shown in FIG. 4. In addition, the circuit board coordinate position symbol 45 of the tuner 54 is displayed as (C01). This indicates that the tuner 54 is arranged on the front surface 3c of the video and voice processing board 33 in a region in which the position display symbol 44 in the X-axis direction 41 is C and in which the position display symbol 44 in the Y-axis direction 42 is 1. Further in the video and voice processing circuit diagram 23, a component symbol 61 corresponding to the capacitor 52 having “C2801” as the reference number 65 is displayed left downward of the component number 64 displayed as “TUN01234” corresponding to the tuner 54. A circuit board coordinate position display symbol 45 of the capacitor 52 is displayed as (C-1) and a front or rear identification symbol 46 thereof is displayed as a white circle. They indicate that this capacitor 52 corresponding to this component symbol 61 is arranged on the front surface 3c of the video and voice processing board 33 in a region in which the position display symbol 44 in the X-axis direction 41 is C and in which the position display symbol 44 in the Y-axis direction 42 is 1. Likewise, front or rear identification symbols 46 are added, as black circles, to the circuit board coordinate position symbols 45 of the capacitor 52 and the inductor 53, the component symbols 61 of which are both displayed below the capacitor 52 having “C2801” as the reference number 65, and which have the reference numbers 65 as “C2802” and “B2802”, respectively. The circuit board coordinate position symbols 45 are displayed in the vicinity of the reference numbers 65 of the capacitor 52 and the inductor 53, respectively. The front or rear identification symbols 46 indicate that the capacitor 52 and the inductor 53 are arranged on the rear surface 3d of the video and voice processing board 33. Further, the front or rear identification symbol 46 added, as a white circle, to the circuit board coordinate position symbol 45 of the resistor 51 having “R2823” as the reference number 65 and displayed in right of the component symbol 61 of the inductor 53 indicates that the resistor 51 is arranged on the front surface 3c of the video and voice processing board 33.

Arrangement and component marks 62 of the electronic components 51, 52, 53, and 54 arranged on the front surface 3c and the rear surface 3d of the video and voice processing board 33 corresponding to the video and voice processing circuit diagram 23 will be described with reference to FIGS. 4 and 5. A reference number 65 is displayed generally at the center of each component mark 62 on each of the front surface 3c and the rear surface 3d of the video and voice processing board 33. If the component mark 62 is small, it is displayed while being partially omitted.

Next, the electronic components indicated to be arranged on the front surface 3c of the video and voice processing board 33 by the front or rear identification symbols 46 displayed as white circles in the vicinity of the reference numbers 65 representing the respective electronic components on the video and voice processing circuit diagram 23 will be described. Among the component symbols 61 representing the electronic components shown in FIG. 3, the tuner 54 having “TU2801” as the reference number 65 is indicated to be arranged on the front surface 3c of the video and voice processing board 33 in a region in which the position display symbol 44 in the X-axis direction 41 is C and in which the position display symbol 44 in the Y-axis direction 42 is 1 by the circuit board coordinate position symbol 45 displayed as (C-1) and the front or rear identification symbol 46 added, as the white circle, to the symbol 45. Likewise, each of the capacitor 52 having “C2801” as the reference symbol 65 and the resistor 51 having “R2823” as the reference symbol 65 is indicated to be arranged on the front surface 3c of the video and voice processing board 33 in a region in which the position display symbol 44 in the X-axis direction 41 is C and in which the position display symbol 44 in the Y-axis direction 42 is 1. Therefore, by comparing the circuit diagram 23 with the board 33, it is possible to easily check at which position on the front surface 3c of this board 33 each of the tuner 54, the capacitor 52, and the resistor 51 is arranged based on the front or rear identification symbol 46 displayed as the white circle and the circuit board coordinate position symbol 45 thereof displayed on the circuit diagram 23.

Furthermore, on the video and voice processing circuit diagram 23 shown in FIG. 3, the capacitor 52 having “C2802” as the reference symbol 65 is indicated to be arranged on the rear surface 3d of the video and voice processing board 33. The capacitor 52 is arranged in a region in which the position display symbol 44 in the X-axis direction 41 is C and in which the position display symbol 44 in the Y-axis direction is 1 on the rear surface 3d of the video and voice processing board 33 shown in FIG. 5 based on the circuit board coordinate position symbol 45 of the capacitor 52 displayed as (C-1) and the front or rear identification symbol 46 added, as the black circle, to the symbol 45. Likewise, the inductor 53 having “B2802” as the reference symbol 65 is indicated to be arranged on the rear surface 3d of the video and voice processing board 33 shown in FIG. 5 in a region in which the position display symbol 44 in the X-axis direction 41 is D and in which the position display symbol 44 in the Y-axis direction 42 is 2 based on the circuit board coordinate position symbol 45 of the inductor 53 displayed as (D-2) and the front or rear identification symbol 46 added, as the black circle, to the symbol 45. Therefore, by comparing the circuit diagram 23 with the board 33, it is possible to easily check at which position on the rear surface 3d of this board 33 each of the capacitor 52 and the inductor 53 is arranged based on the front or rear identification symbol 46 displayed as the black circle and the circuit board coordinate position symbol 45 thereof displayed on the circuit diagram 23.

In FIGS. 4 and 5, divided graduations 43a obtained by further dividing the graduations 43 in the X-axis direction 41 and the Y-axis direction 42 are displayed. It is thereby possible to display the circuit board coordinate position symbols 45 with coordinate positions on the board 33 further divided, and improve coordinate position accuracy on the board 33 by the circuit board coordinate position symbols 45 based on the divided graduations 43a. For example, as shown in FIG. 5, divided position display symbols 44a in the X-axis direction 41 and those in the Y-axis direction 42 are both represented by such lowercase letters of alphabets as a, b, c, d, and e. The circuit board coordinate position symbol 45 (C-1) of the capacitor 52 having “C2802” as the reference number 65 is displayed as (Ce-1c) if using the divided position symbols 44a. Likewise, the circuit board coordinate position symbol 45 (D-2) of the inductor 53 having “B2802” as the reference number 65 can be displayed as (Da-2b ) if using the divided position symbols 44a. It is thereby possible to specify a position of each electronic component in a location in which a plurality of smaller chip-type electronic components or the like are arranged, in detail by displaying the circuit board coordinate position symbol 45 of the electronic component using the divided position display symbols 44a. On the other hand, a larger electronic component spreads over a plurality of regions, which makes it difficult to specify the coordinate position of the electronic component. In this case, both of or either of the position display symbols 44 and the divided position display symbols 44a are used according to sizes of arranged electronic components in such a manner that the circuit board coordinate position symbol 45 of an electronic component is displayed using the position display symbols 44 without using the divided position display symbols 44a. Alternatively, by freely changing intervals of the graduations 43 according to the sizes of the electronic components, it is possible to facilitate specifying the coordinate positions on the board 33 of the electronic components.

Thus, each of the specific electronic components 51, 52, 53, and 54, for example, the inductor 53 having “B2802” as the reference number 65 and arranged on the rear surface 3d of the board 33 is located while the video and voice processing circuit diagram 23 is compared with the video and voice processing board 33 as follows. The combination of the circuit board coordinate position symbol 45 and the front or rear identification symbol 46 that is relatively noticeable is selected from among a plurality of display symbols 60 displayed on the video and voice processing circuit diagram 23. Among them, the generally rectangular component symbol 61 that represents the inductor 53 and the reference number 65 thereof displayed as “B2802” are located, thereby specifying this inductor 53. Alternatively, this inductor 53 may be specified by display of the component symbol 61 thereof and the reference number 65 displayed as “B2802”. By comparing the circuit diagram 23 with the board 33, the arranged position of the inductor 53 on the board 33 can be specified based on the display of the circuit board coordinate position symbol 45 and the front or rear identification symbol 46 displayed on the circuit diagram 23. In addition, the rated value 63 and the like can be read based on the display of the component number 64 thereof as “BLM18BB750SN1” using a separately prepared component list.

According to this embodiment, even if the electronic components 51, 52, 53, and 54 are arranged on the front surface 3c and the rear surface 3d of the video and voice processing board 33, it is possible to easily specify on which surface the respective electronic components are arranged, on the front surface 3c or on the rear surface 3d of the video and voice processing board 33, only by referring to the video and voice processing circuit diagram 23. Therefore, if the specific electronic components 51, 52, 53, and 54 arranged on the video and voice processing board 33 incorporated in the television set 1 are checked or repaired when a failure occurs to the television set 1, the component symbols 61 displayed on the video and voice processing circuit diagram 23 and corresponding to the reference numbers 65 or the component marks 62 of the specific electronic components 51, 52, 53, and 54 arranged on the front surface 3c or the rear surface 3d of the board 33 of the television set 1 can be easily located on the video and voice processing circuit diagram 23 while comparing the board 33 with the circuit diagram 23. Since the reference numbers 65 or the component symbols 61 representing the respective electronic components 51, 52, 53, and 54 and displayed on the circuit diagram 23, and the wiring, signal path or the like among the respective component symbols 61 on the circuit diagram 33 can be easily grasped, it is possible to check a fault portion, check the component number 64 and the rated value 63 of one of the electronic components 51, 52, 53, and 54 to which the failure occurs, and promptly repair the fault portion.

As can be seen, according to this embodiment, it is possible to solve the following conventional disadvantages. According to the conventional techniques, even if the front or rear identification symbols 46 indicating on which surface the electronic components 51, 52, 53, and 54 are arranged, on the front surface 3c or on the rear surface 3d of board 32 or 33, are displayed in the vicinity of the component symbols 61 or the reference numbers 65 representing the respective electronic components 51, 52, 53, and 54 and displayed on the circuit diagram 22 or 23, the coordinate positions on the board 32 or 33 of the electronic components 51, 52, 53, and 54 are not displayed on the circuit diagram 22 or 23. Due to this, the specific electronic components 51, 52, 53, and 54 cannot be easily located from among the plural electronic components 51, 52, 53, and 54 arranged on the board 32 or 33. Conversely, the specific component symbols 61 displayed on the circuit diagram 22 or 23 and representing the specific electronic components 51, 52, 53, and 54 cannot be easily located from among the plural component symbols 61 displayed on the circuit diagram 22 or 23 and representing the plural electronic components 51, 52, 53, and 54 arranged on the board 32 or 33. According to this embodiment, by contrast, the coordinate positions on the board 32 or 33 of the electronic components 51, 52, 53, and 54 and on which surface the respective electronic components 51, 52, 53, and 54 are arranged, on the front surface 3c or on the rear surface 3d of the board 32 or 33, are indicated on the circuit diagram 22 or 23 by displaying thereon the circuit board coordinate position symbols 45 and the front or rear identification symbols 46 thereof. Alternatively, the coordinate positions on the circuit diagram 22 or 23 of the component symbols 61 and the like representing the electronic components 51, 52, 53, and 54 and displayed on the circuit diagram 22 or 23 may be displayed separately for the respective front surface 3c and the rear surface 3d of the board 32 or 33. By doing so, the specific electronic components 51, 52, 53, and 54 arranged on the front surface 3c and the rear surface 3d of the board 32 or 33 can be easily located by the circuit board coordinate position symbols 45 and the front or rear identification symbols 46 thereof displayed on the circuit diagram 22 or 23. In addition, the specific component symbols 61 and the like displayed on the circuit diagram 22 or 23 and representing the specific electronic components 51, 52, 53, and 54 can be easily located by the circuit diagram coordinate position symbols 55 thereof displayed on the front surface 3c or the rear surface 3d of the board 32 or 33. According to this embodiment, the graduations 43 are displayed at certain intervals. However, the graduations 43 are not necessarily displayed at certain intervals but the intervals of the graduations 43 may be arbitrarily changed according to the sizes of the arranged electronic components. It suffices as long as the graduations 43 can specify the coordinate positions on the board 32 or 33 of the electronic components.

The embodiments of the present invention have been described so far in detail. However, various changes and modifications can be made within the scope of the spirit of the present invention. For example, the display of the graduations 43 and the divided graduations 43a is not limited on the outer periphery 21 of the circuit diagram 22 or 23 and the outer periphery 31 of the board 32 or 33. They may be displayed generally in a checkered fashion on entire surfaces of the circuit diagram 22 or 23 and the board 32 or 33 so as to facilitate specifying the coordinate positions. Namely, it suffices as long as the graduations 43 and the divided graduations 43a can easily specify the coordinate positions. Further, if a plurality of circuit diagrams 22 or 23 are formed for one board 32 or 33, circuit diagram identification symbols that identify the first circuit diagram 22 or 23 and those that identify the second circuit diagram 22 or 23 or he like similarly to the front or rear identification symbols 46 are displayed while being added to the circuit diagram coordinate position symbols 55 displayed on the board 32 or 33 and corresponding to the respective electronic components. Appropriate symbols may be, therefore, added.

1. An electronic apparatus that includes a printed circuit board, the printed circuit board formed by a board design CAD apparatus according to a board design corresponding to a circuit diagram designed by a circuit design CAD apparatus,
the printed circuit board having graduations displayed both in an X-axis direction and a Y-axis direction on an outer periphery thereof, while the X-axis direction and the Y-axis direction are specified, and
the printed circuit board further having a position indication symbol displayed for indicating a position defined by the graduations, hereby enabling coordinate positions on the printed circuit board of the respective electronic components arranged on the printed circuit board to be identified by the graduations and the position indication symbol both displayed on the printed circuit board, wherein
the circuit design CAD apparatus stores and holds coordinate position data on the respective electronic components arranged on the printed circuit board designed by the board design CAD apparatus,
the circuit design CAD apparatus displays circuit board coordinate position symbols of the respective electronic components based on the stored and held coordinate position data in the vicinity of component display symbols representing the respective electronic components and displayed on the circuit diagram of the printed circuit board, and
the coordinate positions of the respective electronic components on the printed circuit board can be identified by the circuit board coordinate position symbols displayed on the circuit diagram.

2. The electronic apparatus that includes the printed circuit board according to claim 1,
the circuit diagram of the printed circuit board having graduations displayed on an outer periphery of the circuit diagram both in the X-axis direction and the Y-axis direction, while the X-axis direction and the Y-axis direction are specified, and
the circuit diagram further having a position indication symbol displayed for indicating a position defined by the graduations, hereby enabling coordinate positions on the circuit diagram of respective component display symbols displayed on the circuit diagram and corresponding to the respective electronic components arranged on the printed circuit board to be identified by the graduations and the position indication symbol both displayed on the circuit diagram, wherein
the board design CAD apparatus stores and holds coordinate position data on the respective component display symbols representing the respective electronic components and displayed on the circuit diagram by the circuit design CAD apparatus,
the board design CAD apparatus displays circuit diagram coordinate position symbols of the respective component display symbols based on the stored and held coordinate position data in the vicinity of component arrangement symbols displayed on the printed circuit board for specifying the positions to arrange the respective electronic components on the printed circuit board, and
the coordinate positions on the circuit diagram of the respective component display symbols representing the respective electronic components can be identified by the circuit diagram coordinate position symbols displayed on the printed circuit board.

3. The electronic apparatus that includes the printed circuit board according to claim 1, wherein
the circuit board coordinate position symbols corresponding to the respective electronic components and displayed on the circuit diagram are displayed while front or rear identification symbols that specify a front surface or a rear surface of the printed circuit board are added to the circuit board coordinate position symbols, the front or rear identification symbols making it possible to specify on which surface of the printed circuit board the respective electronic components are arranged, on the front surface or on the rear surface of the printed circuit board.

4. The electronic apparatus that includes the printed circuit board according to claim 2, wherein
the circuit board coordinate position symbols corresponding to the respective electronic components and displayed on the circuit diagram are displayed while front or rear identification symbols that specify a front surface or a rear surface of the printed circuit board are added to the circuit board coordinate position symbols, the front or rear identification symbols making it possible to specify on which surface of the printed circuit board the respective electronic components are arranged, on the front surface or on the rear surface of the printed circuit board.
